(19) United States
(12) Patent Application Publication
(10) Pub. No.: US 2013/0153396 A1
(43) Pub. Date: Jun. 20, 2013

(54) Purification of a fluid for example water after fracturing

(71) Applicant: Charles Wilson, Frisco, TX (US)

(72) Inventor: Charles Wilson, Frisco, TX (US)

(21) Appl. No.: 13/326,990

(22) Filed: Dec. 15, 2011

(51) Int. Cl. B01D 3/10

(52) U.S. Cl. 202/175

(57) ABSTRACT

An apparatus for treating frac water may include a vacuum container to support a vacuum, a heating device to heat the vacuum container, a spiral auger to rotate to separate the frac water being positioned within the vacuum container, a condenser to condense the water vapor to liquid water, a second vacuum chamber to receive the liquid water and a storage container to store the liquid water.

### FIELD OF THE INVENTION

The present invention relates to fracturing and more particularly to the purification of a fluid for example water after fracturing.

### BACKGROUND

Hydraulic fracturing, often called fracking, fracing or hydrofracking, is the process of initiating and subsequently propagating a fracture in a rock layer, employing the pressure of a fluid as the source of energy. The fracturing, known as a frack job (or frac job), is done from a wellbore drilled into reservoir rock formations, in order to increase the extraction and ultimate recovery rates of oil and natural gas.

Hydraulic fractures may be natural or man-made and are extended by internal fluid pressure which opens the fracture and causes it to extend through the rock. Natural hydraulic fractures include volcanic dikes, sills and fracturing by ice as in frost weathering. Man-made fluid-driven fractures are formed at depth in a borehole and extend into targeted formations. The fracture width is typically maintained after the injection by introducing a proppant into the injected fluid. Proppant is a material, such as grains of sand, ceramic, or other particulates, that prevent the fractures from closing when the injection is stopped.

One use of hydraulic fracturing is in stimulating water wells. In that case, the fluid used may be pure water (typically water and a disinfectant such as bleach).

Frac water may be water and various minerals and debris that results from fracturing. The frat water must be processed to eliminate the minerals and debris so that the substantially pure water may be returned to the environment.

### SUMMARY

An apparatus for treating frac water may include a vacuum container to support a vacuum, a heating device to heat the vacuum container, a spiral auger to rotate to separate the frac water being positioned within the vacuum container, a condenser to condense the water vapor to liquid water, a second vacuum chamber to receive the liquid water and a storage container to store the liquid water.

The vacuum container may maintain a sufficient vacuum to boil water at approximately 100° F. and to form water vapor;

The vacuum chamber may include a substantially circular cross-section.

The vacuum chamber may include a input port to receive the frac water.

The vacuum chamber may include a first output port to discharge the debris.

The vacuum chamber may include a second output port to discharge the water vapor.

A first passageway may connect the vacuum chamber and the condenser chamber.

A second passageway may connect the second vacuum chamber and the condenser chamber.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side cross-sectional view of the fluid purification device of the present invention;

FIG. 2 illustrates an end cross-sectional view of the fluid purification device of the present invention;

FIG. 3 illustrates a flow diagram of the steps of the present invention.

### DETAILED DESCRIPTION

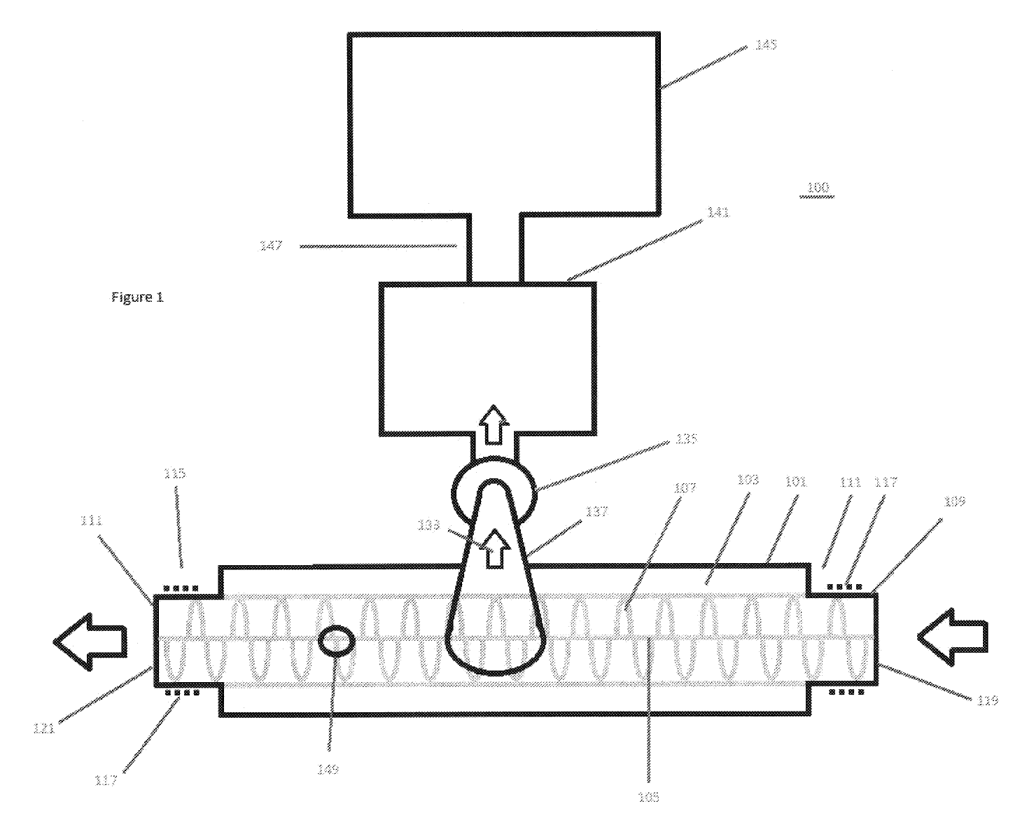

FIG. 1 illustrates a fluid purification device 100 of the present invention which may include a vacuum container 101 which may be substantially an elongated cylinder which may be formed from metal, steel, glass, plastic or other type of material and which may be a hollow cylinder. The vacuum container 101 may define a vacuum cavity 103. The vacuum container 101 may include a rotatable shaft 105 which may extend through the longitudinal direction of the vacuum container 101 and which may include a spiral auger 107 which may include an auger blade which may be relatively thick and impregnated to include a non-stick surface as well as the trough the auger rest in. The vacuum container 101 may include an input narrow portion 109 which may define a input shoulder 113 and a output narrow portion 111 which may define an output shoulder 115. O-rings may extend around the interior surface of the input narrow portion 109 and the output narrow portion 111 to provide a seal for the shaft 105 and the spiral auger 107. FIG. 1 additionally illustrates a pressure relief valve 149 to relieve the pressure within the vacuum container 101 if the pressure should exceed a predetermined pressure value.

In operation, a vacuum sufficient to boil water at substantially hundred degrees Fahrenheit is formed within the vacuum cavity 103 and frac fluid which may be frac water enters the input port 119 of the input narrow portion 109. The rotating shaft 105 rotates the spiral auger 107 to help separate the water from the debris and minerals. Additionally, the vacuum encourages the water to enter the vapor state to encourage the separation from the debris and materials. The debris material and minerals and perhaps some water produced output from the vacuum chamber 101 through the first outlet port 131.

FIG. 1 additionally illustrates a second output port 133 which may be positioned at the top of the vacuum container 101 and which may be connected to a first transfer passageway 137 which may be a tube to allow the water vapor which has been vaporized within the vapor container 101 to be transferred to the condenser 135. The first transfer passageway 137 may be connected to the condenser 135 to transfer the water vapor (steam) from the vacuum container 101 to the condenser 135.

The condenser 135 condenses the water vapor to liquid water which now should be substantially pure. The liquid water enters a vacuum chamber 141 by a second transfer passageway 143 which may connect the condenser 135 and the vacuum chamber 141. The substantially pure water may be transferred from the vacuum chamber 141 to a storage container 145 through a third transfer passageway 147. The water may be stored in the storage container 145 until needed.

The pressure inside the vacuum container 101 and the vacuum chamber 141 may be between substantially 0.25 to 2 lbs/inch. The operating temperature of the vacuum container 101 and the vacuum chamber 141 may be between substantially 400 to 500 degrees Fahrenheit. The pressure is equivalent to exposing the frac water to the atmospheric pressure at substantially 50,000 to 80,000 feet above the surface of the earth. At this altitude and correspondingly in the vacuum container 101 and the vacuum chamber 141 water may boil at room temperature and may boil below room temperature. The operating temperature may allow the frac water to flash boil. The agitation of the frac water may compensate for the low pressure within the vacuum container 101 and the vacuum chamber 141 With so little pressure the inside of the vacuum chamber 141 and the vacuum container 101 unit a portion of the heat may need to be transferred by physical contact of the rotating shaft 105. Since the vacuum may provide insulation, the heating requirements may be reduced. The heat may transfer to the frac water by contact with the rotating shaft 105 and the interior surface of the vacuum container 101. This apparatus may facilitate the processing of large volumes of frac water at a constant rate.

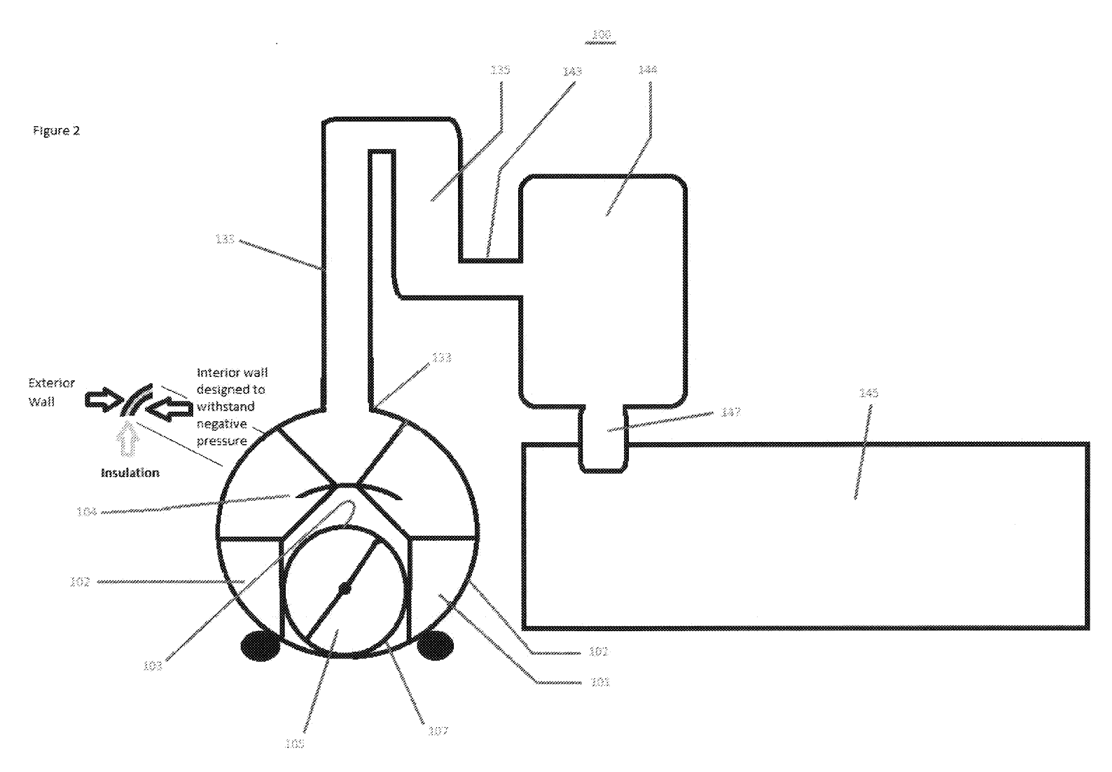

FIG. 2 illustrates a fluid purification device 100 of the present invention which may include a vacuum container 101 which may be substantially an elongated cylinder which may be formed from metal, steel, glass, plastic or other type of material and which may be a hollow cylinder. The vacuum container 101 may define a vacuum cavity 103. The vacuum container 101 may include a rotatable shaft 105 which may extend through the longitudinal direction of the vacuum container 101 and which may include a spiral auger 107 which may include an auger blade which may be relatively thick and impregnated to include a non-stick surface as well as the trough the auger rest in. A splash guard 104 may cooperate with the auger blade in order to limiting the splashing of the fluid. The vacuum container 101 may include an input narrow portion 109 which may define a input shoulder 113 and a output narrow portion 111 which may define an output shoulder 115 (not shown in FIG. 2). O-rings may extend around the interior surface of the input narrow portion 109 and the output narrow portion 111 to provide a seal for the shaft 105 and the spiral auger 107. A pressure relief valve 149 relieves the pressure within the vacuum container 101 if the pressure should exceed a predetermined pressure value (not shown in FIG. 2). FIG. 2 illustrates opposing heating devices 102 which may be positioned on opposing sides of the auger 107 which may extend the substantial length of the vacuum container 101 and provide heat to keep the temperature within the vacuum container 101 at approximately 100° plus or minus a range of xxx. The vacuum may be sufficient to cause the liquid water to boil into a vapor state and may fall within the range of xxx atmospheres.

FIG. 2 additionally illustrates a second output port 133 which may be positioned at the top of the vacuum container 101 and which may be connected to a first transfer passageway 137 which may be a tube to allow the water vapor which has been vaporized within the vapor container 101 to be transferred to the condenser 135. The first transfer passageway 137 may be connected to the condenser 135 to transfer the water vapor (steam) from the vacuum container 101 to the condenser 135.

The condenser 135 condenses the water vapor to liquid water which now should be substantially pure. The liquid water enters a vacuum chamber 141 by a second transfer passageway 143 which may connect the condenser 135 and the vacuum chamber 141. The substantially pure water may be transferred from the vacuum chamber 141 to a storage container 145 through a third transfer passageway 147. The water may be stored in the storage container 145 until needed.

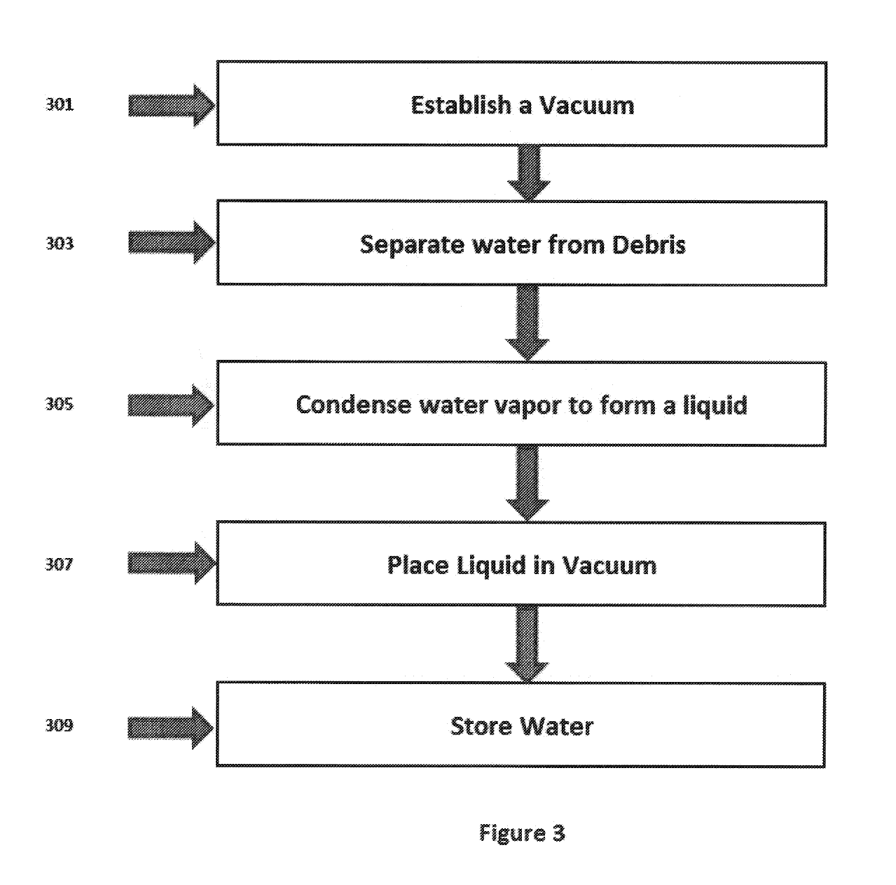

FIG. 3 illustrates the steps of the present invention and illustrates establishing a vacuum in step 301, separating water from debris in the vacuum in step 303, condensing the separated water vapor to form a liquid in step 305 and storing the water in step 309.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An apparatus for treating frac water, comprising:
a vacuum container to support a vacuum;
a heating device to heat the vacuum container;
a spiral auger to rotate to separate the frac water being positioned within the vacuum container;
wherein the vacuum container maintains a sufficient vacuum to boil water at approximately 100° F. and to form water vapor;
a condenser to condense the water vapor to liquid water;
a second vacuum chamber to receive the liquid water; and
a storage container to store the liquid water.

2. An apparatus for treating frac water as in claim 1, wherein the vacuum chamber includes a substantially circular cross-section.

3. An apparatus for treating frac water as in claim 1, wherein the vacuum chamber includes a input port to receive the frac water.

4. An apparatus for treating frac water as in claim 1, wherein the vacuum chamber includes a first output port to discharge the debris.

5. An apparatus for treating frac water as in claim 1, wherein the vacuum chamber includes a second output port to discharge the water vapor.

6. An apparatus for treating frac water as in claim 1, wherein a first passageway connects the vacuum chamber and the condenser chamber.

7. An apparatus for treating frac water as in claim 1, wherein a second passageway connects the second vacuum chamber and the condenser chamber.
